(19) United States
(12) Patent Application Publication
(10) Pub. No.: US 2003/0078789 A1
(43) Pub. Date: Apr. 24, 2003

(54) Method and system for administrating consumer club membership cards

(76) Inventor: Zvi Oren, Tel Aviv (IL)

Correspondence Address: BROWDY AND NEIMARK, P.L.L.C., 624 NINTH STREET, NW, SUITE 300, WASHINGTON, DC, 20001-5303, US

(21) Appl. No.: 09/982,118

(22) Filed: Oct. 19, 2001

(51) Int. Cl. G06F 17/60

(52) U.S. Cl. 705/1

(57) ABSTRACT

A method and system for administering membership of a club, wherein a club administrator maintains a portfolio of a subscriber's clubs including details of each club of which the subscriber is a member, and conveys to a portable subscriber unit details of at least one club for displaying membership certification thereof on a display of the subscriber unit. The club portfolio may be stored in a memory of the portable subscriber unit, which may be a cellular telephone and may include identity data of the registered owner of the portable subscriber unit, including the owner's picture. The memory may be a standalone module adapted for use with a cellular telephone having a suitable interface and the data may be updated by the club administrator so as to ensure that the data is constantly current. In use, the registered owner can display information attesting to his or her membership of a club, thus obviating the need to carry large numbers of club membership cards. In the event of loss, the club administrator or a service provider mediating between the club administrator and the subscriber can disable use of the portable subscriber unit so as to prevent an unauthorized party from accessing club membership data or from using it fraudulently. The invention further contemplates a chain of retail outlets under the aegis of the club administrator for facilitating joining of consumer clubs and promoting those clubs that are affiliated with the club administrator.

### FIELD OF THE INVENTION

This invention relates to consumer club membership cards and in particular to a method for centralizing management thereof.

### BACKGROUND OF THE INVENTION

The proliferation of plastic cards similar to familiar credit cards has changed the way people manage their daily lives. It is not an exaggeration to say that such cards are fast becoming the key to a host of services, which are either unavailable at all or are available at less attractive terms to those not having an appropriate membership card. Thus, club membership cards of various types of consumer clubs are becoming increasingly popular. Within the context of the present invention the term “club membership” has a very wide meaning. Thus, apart from actual clubs, which issue membership cards to their members, it is known, for example, for stores to issue such cards to registered customers who are then offered favorable status, receiving discounts or special offers not available to non-members. This increases the loyalty of such customers to those stores of which they are “members” and discourages them form diversifying and “shopping around” at different stores. Likewise, frequent flyers are supplied with similar cards, basically for the same reason: to discourage them from flying with other airline carriers.

All these cards are similar in basic structure, comprising a plastic substrate of a size adapted to fit in a wallet and often having a magnetic stripe or embedded processor, in which there are encoded relevant details of the “club member”. People tend to fall into one of two types: those who resist belonging to clubs and those who register with as many clubs as they can—particularly if there are no membership fees required. As noted above, this is indeed very often the case, because club membership serves as an incentive to make use of the club facilities, whatever they may be, and these, of course, bring revenue to the club management. Consequently, it is by no means uncommon that those who are “club types” belong to many clubs and these people are then faced with the problem of how best to carry all these cards. Thus, their sheer bulk militates against their being accommodated in the limited space usually provided in wallets for this purpose. As a result, owners tend to be selective and carry on their person at any given time only those cards that are most likely to be required in the immediate future. This, of course, is prone to “Murphy's Law” which dictates that the very card they will need, will be the one they left at home; but even apart from this it places the onus of managing their membership cards on the owner. Thus, the owner is stranded between two equally undesirable alternatives: on the one hand, to carry all his or her membership cards in spite of the inconvenience, or on the other hand to run the risk of being without a card when needed.

Even apart from the bulk and inconvenience of carrying membership cards, the management of the cards is also problematical for several reasons. Thus, from the club member's point of view, if his or her personal details change, then it may be necessary to inform a large number of different organizations of the new data so that they can update their records accordingly. It is not always easy to keep track of which those organizations to which a member belongs, particularly when there are very many of them. Moreover, it may also be necessary to replace the membership card, thus placing a further burden both on the organization responsible for maintenance of the club membership database and card issue; and also on the member who may have to go personally to collect, and maybe sign for, the replacement card.

Statistics suggest that the majority of consumer clubs collapse for two main reasons. First, they are not sufficiently attractive to the client and are not sufficiently large to be able to finance meaningful cost benefits to the client. As a result, the client has insufficient incentive to carry the membership cards. Secondly, the large costs associated with management of the consumer club are crippling: particularly the printing and postage costs in sending mail to members. Thus, for example, an average size consumer club having 250,000 members is likely to incur monthly costs of hundreds of thousands of dollars just in mailing invoices, fliers and other information to its members. Consumer clubs face a major marketing problem to convince their customers to join their club. In many cases, where a consumer club is affiliated to a store used by a consumer, some inducement is made to attract the consumer to join before checking out his goods. However, many consumers reject the offer owing to the inconvenience of filling out application forms while they are standing on line waiting to pay for their purchases.

Many of the club members make no effort to notify the club of changes in their personal details, such as: new address, new phone number etc., and as a result a great deal of printed mail does not reach the consumer. If the consumer loses his wallet he has to call the various clubs to block his cards.

U.S. Pat. No. 5,884,271 (Pitroda; Satyan G) entitled “Device, system and methods of conducting paperless transactions” discloses a universal electronic transaction card capable of serving as a number of different credit cards, bank cards, identification cards, employee cards, medical and health care management cards and the like. The card includes storage elements, an input interface, a processor, a display, and a communications interface. In a preferred embodiment, the card stores transactional information to eliminate paper receipts and includes security features to prevent unauthorized use. The card may also be used to replace conventional currency and traveler's checks, and may be configured to store and display promotional information, such as advertising and incentives.

The system disclosed by Pitroda is principally directed to the elimination or reduction of the amount of paper associated with multiple transactions, so as to reduce the costs of providing credit card services and to automate payment of such transactions, thus reducing human error. The system is equally applicable to the health care industry, where each visit by a patient to a doctor may result in filling out one or more insurance forms that are, in turn, sent to insurance companies for processing.

Pitroda also relates to the above-mentioned inconvenience of carrying a large number of cards, such as multiple credit cards, insurance cards, drivers' licenses, airline cards, check identification cards, ATM cards, and employee identification cards. In particular, he relates to the burden of financial accounting associated with these cards related to paying bills, keeping track of accounts, budgeting, planning and so on. He also relates to the need to replace the cards periodically and to the inconvenience and cost in doing so.

The universal electronic transaction card proposed by Pitroda is capable of storing, transmitting and receiving personal and transactional information and thereby replacing plastic cards, which are presently used for the same purpose.

There is no suggestion by Pitroda to use the universal electronic transaction card to manage an owner's club portfolio, even accepting a broad definition of “club” encompassing health funds, hotels, financial institutions, sales outlets and the like. Likewise, Pitroda makes no suggestion to update data stored in a memory of the universal electronic transaction card so as to obviate the need for the owner to keep track of his or her club membership and to renew the membership when necessary. while he relates to the need to replace the cards periodically and to the inconvenience and cost in doing so, he appears to offer no solution to this problem.

Pitroda discloses a central processing authority, but makes no suggestion to use such a central processing authority for the purpose of centralizing a club member's personal details so as to disseminate these details to all clubs of which he or she is a member: again, so as to avoid the need for the member to do this on a club-by-club basis. Moreover, so far as it can be understood, the central processing authority disclosed by Pitroda relates to the transaction for which the universal electronic transaction card is being used. Thus, in a detailed scenario which Pitroda describes in connection with the health care system, the central processing authority is a central health care processing system. It is not a central authority that manages a club member's memberships of all clubs, even though those clubs have no common denominator—other, of course, than the fact that the card owner is a member of all of them.

It would therefore clearly be an advantage to provide a universal club membership card to serve as a vehicle, in conjunction with a central authority, to manage all of an owner's club memberships, to display relevant data on a display device of the card and to attend to the updating of a member's personal details. It would be a further advantage to provide a system that would enable a consumer to join multiple consumer clubs with a minimum of fuss and avoid the massive form filling that all too often accompanies this task in current practice.

### SUMMARY OF THE INVENTION

It is therefore an object of the present invention to provide a method and system for certifying and maintaining membership of a club, where registration and certification are managed through the medium of a central club administrator.

This objective is realized in accordance with a first aspect of the invention by a method for administering membership of a consumer club, comprising the following steps all carried out by a club administrator:

(a) maintaining a database of subscribers and details of each consumer club of which each subscriber is a member, and

(b) conveying to a portable subscriber unit details of at least one club for certifying membership of the at least one club.

According to a second aspect of the invention there is provided a method for administering membership of a consumer club, comprising the following steps all carried out by a portable subscriber unit or by an owner thereof:

(a) downloading from a club administrator details of at least one consumer club of which an owner of the subscriber unit is a member, and

(b) using the subscriber unit to certify membership of said at least one consumer club.

Preferably the portable subscriber unit is a cellular telephone or a smart card. According to the invention, the portable subscriber unit may be equipped with a memory module containing one or more personal folders in which details of the owner's club memberships transmitted by the club administrator may be stored, allowing presentation on a display device of the cellular telephone of pertinent details and obviating the need for communication with the club administrator so as to extract data from the club administrator's database each time club membership certification is required. On the other hand, any changes in the owner's personal details such as address, telephone number, marital status, and so on may be communicated to the club administrator so as to be reflected by the club administrator in all of the owner's club membership portfolio, after receiving confirmation that the changes have been received and recorded by each club. The details of the consumer club stored in the database may include, for each registered consumer, name, membership no, validity period, discount rate, upgrade, bonus points, mileage etc. The club administrator may also maintain a network of sales outlets for allowing a consumer to register with the consumer club administrator and apply for membership of one or more consumer clubs. To this end, there may be provided a chain of retail stores that sell and promote the consumer clubs to the consumers. The outlets may be like Internet cafes, equipped with computers coupled to the club administrator over the Internet or any other data communications network.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is a flow diagram showing an overview of a method according to the invention during communication between a subscriber and the club administrator;

FIG. 2 is a flow diagram showing the principal operating steps in a method for administering club membership records carried out by the club administrator;

FIGS. 3 to 5 are flow diagrams showing the principal operating steps in a method for administering club membership records carried out by a subscriber unit according to various aspects of the invention;

FIG. 6 is a flow diagram showing the principal operating steps associated with a registration process carried out by a club administrator;

FIG. 7 is a block diagram showing functionally a system according to the invention;

FIG. 8 is a flow diagram showing the principal operating steps associated with a service offered by a public utility for mediating between the subscriber unit and the club administrator;

FIG. 9 is a flow diagram showing the principal operating steps associated with a registration process carried out by a club;

FIG. 10 is a flow diagram showing the principal operating steps associated with a method according to the invention for allowing simplified membership to one or more consumer clubs;

FIG. 11 is a flow diagram showing the principal operating steps associated with a method according to the invention for financing transactions made by consumers when purchasing from stores operating consumer clubs of which the consumer is a member; and

FIG. 12 is a block diagram showing functionally a consumer module used by an authorized officer of the club for interrogating a consumer's subscriber unit.

### DETAILED DESCRIPTION OF THE INVENTION

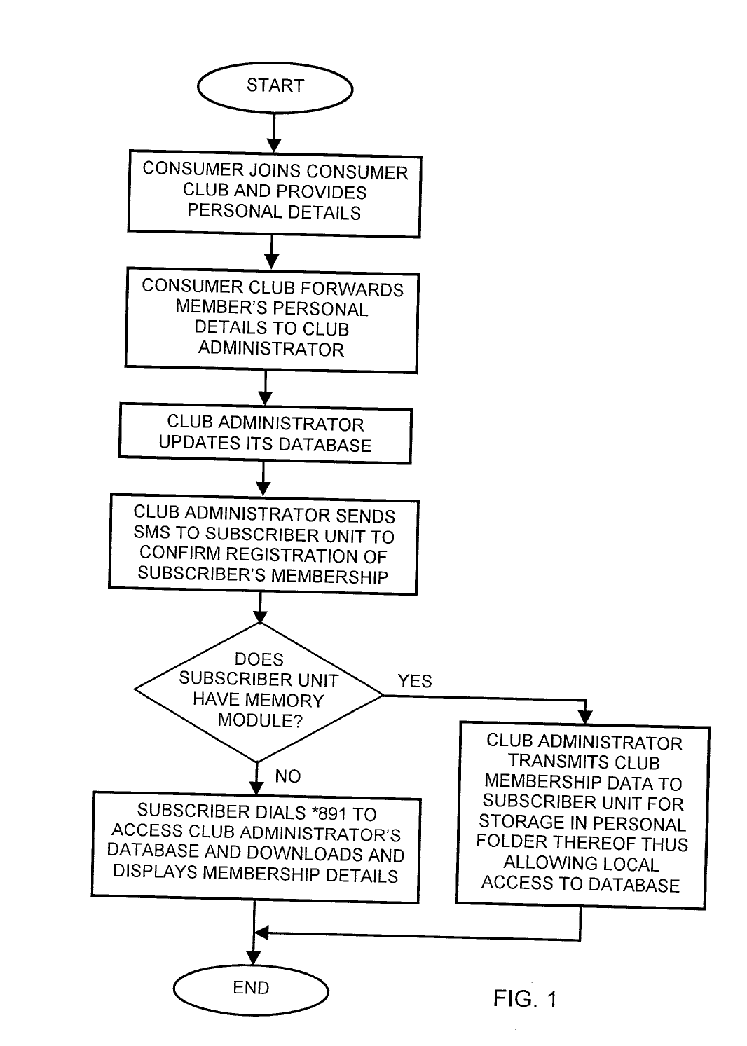

FIG. 1 is a flow diagram showing a method for allowing a new member to join a consumer club and register with the club administrator. Thus, on joining the consumer club, the consumer provides his personal details such as name, address and the like as well as a telephone number allowing the club administrator to communicate directly with a portable subscriber unit belonging to the club member. The club forwards those of the member's personal details that are relevant to the club administrator, which then updates its database. The details of the consumer club stored in the database may also include, for each registered consumer, name, membership no, validity period, discount rate, upgrade, bonus points, mileage etc. Some of these details will depend on the scope of the consumer's patronage of the consumer club or of the enterprise affiliated therewith. For example, credit for air miles given by airlines will increase as the consumer clocks up air miles and this must be reflected in the database. The club administrator communicates with the subscriber unit sends a message confirming registration of the consumer in the consumer club. As noted above, the subscriber unit may be a cellular telephone. In such case, two approaches are envisaged. Most simply, the subscriber unit accesses the database in the club administrator each time proof of membership is required. This can be done by dialing special service code provided by the cellular service provider such as “*891”, whereupon communication between the club administrator and the subscriber unit is initiated, allowing the consumer to enter into a dialog with the club administrator so as to inform the club administrator of the consumer club, for whose membership certification is required. A drawback with such an approach is that the subscriber must pay for the cost of a telephone call each time certified club membership is required. Therefore, alternatively, a memory module may be provided in the subscriber unit and the club membership data pertaining to this member may be conveyed by the club administrator for storage in the memory module, thus obviating the need to communicate with the club administrator each time the consumer wishes to prove membership of a specified consumer club. By thus minimizing the need to access the club administrator, cellular telephone charges (and other associated overheads) may be reduced. In the case that the subscriber unit is a smart card, this is the typical mode of operation and data may be conveyed from the club administrator for storage in the smart card's memory module according to known methods for smart card communication. The memory module in the cellular telephone has the potential to substitute all other personal certificates that will be administered by the club administrator, including those requiring visual proof of the bearer's identity.

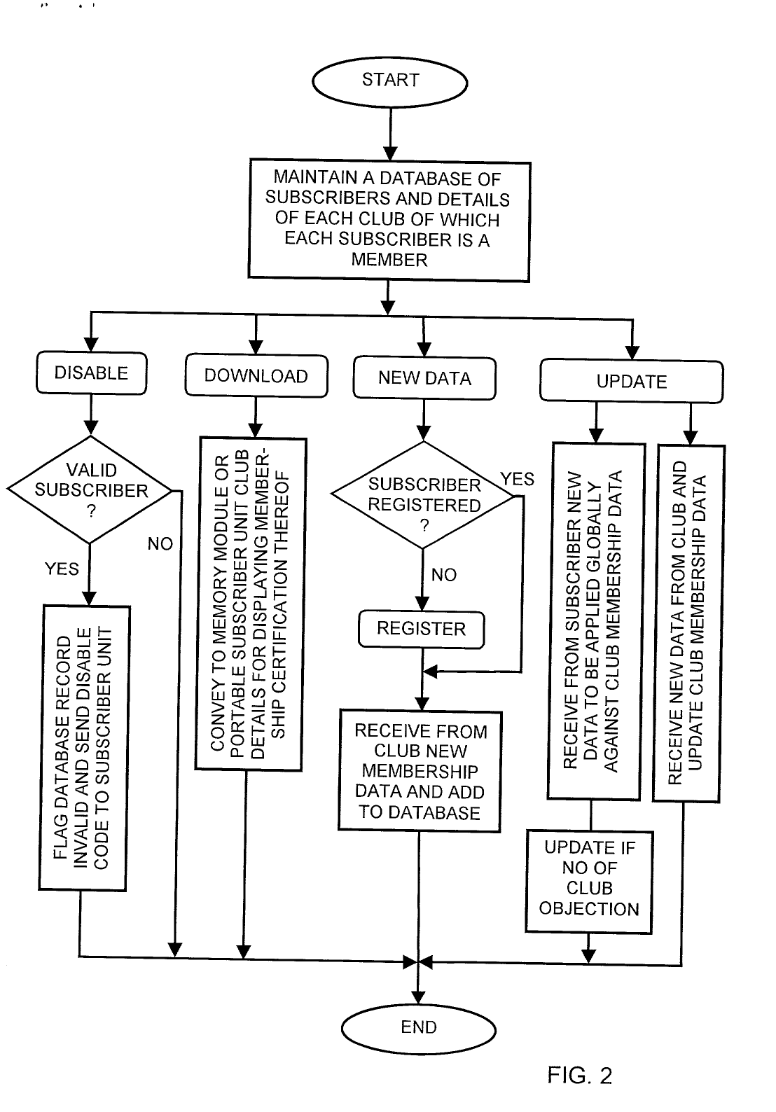

Referring to FIG. 2 there is shown a method for administering membership of a club. A club administrator maintains a database of subscribers and details of each club of which each subscriber is a member including subscriber-dependent data as explained above, and conveys details to a portable subscriber unit of at least one club for displaying membership certification thereof on the subscriber unit. Regardless of whether the subscriber accesses club membership data locally or by accessing the club administrator, the club administrator may convey to the subscriber unit information in the database relating to a registered owner of the subscriber unit. The transmitted information may then be stored in a memory of the subscriber unit so as to allow local access thereto by the owner. This allows the subscriber to download all club membership data to the subscriber unit, although as noted above this may be subject to communication charges. However, such facility is important since it allows updated information in the club administrator database to be copied to the memory module in the subscriber unit, after which subsequent access to the data may be effected locally without the need to access the club administrator. This is necessary when, for example, the subscriber joins a new consumer club or when his or her personal details change. In either case the club administrator must upload the new data to the memory module of the subscriber unit so that the subscriber unit correctly reflects the current data in the club administrator's database.

In such case, the subscriber unit is valuable as a standalone or “off-line” module and clearly the data stored therein must be protected against loss and fraudulent use. To this end, several tiers of protection may be provided. Global protection is achieved by allowing the subscriber unit to be disabled from accessing information stored in the subscriber unit in response to a request by the owner thereof. In the case where the subscriber unit is a cellular telephone, the cellular telephone subscriber may be registered with the cellular service provider to access the service described above. By such means, only those cellular telephone subscribers who are registered may access the club administrator and thus unregistered subscribers are unable to benefit from updates downloaded thereto by the club administrator. If the cellular telephone is reported as lost, all the cellular service provider need do is disable the telephone number in its subscriber database. In the same manner, the cellular telephone can disable any cellular telephone from accessing the club administrator. Alternatively or additionally, the subscriber may be required to enter a personal identity code (PIN) for accessing information in the club administrator's database or in the memory module in the case of the standalone option. In the case of the “on-line” option, the club administrator receives and verifies the PIN, while in the case of the standalone option software within the cellular telephone verifies the PIN. In either case, only if it is valid, are the requested details made available for display by the subscriber unit.

The subscriber unit allows the user to request that information stored in the database of the club administrator be updated, and where applicable also in its own memory module containing one or more personal folders, each belonging to an authorized user of the subscriber unit. For example, a change of address or of telephone number, marital status and so on can be entered by the user once only to the subscriber unit for conveying to the club administrator, thus allowing the club administrator to amend its records for all clubs of which the subscriber is a member. Upon receiving confirmation from each club that the requested change has been noted, the club administrator effects the necessary change to each record in its database relating to the club member. This obviates the need for the club member to inform each club separately.

The details stored in the memory module or uploaded to the subscriber unit from the club administrator database may also include identity data for identifying the owner of the subscriber unit as a genuine club member. The identity data may include data representative of an image of the owner that is conveyed to the subscriber unit for storage in the memory module thereof for display on a display device of the subscriber unit.

Club data may be conveyed to the club administrator by the consumer clubs themselves either on the club's initiative or on the initiative of the club administrator upon being so authorized by the club member. In the first case, a club employing the club administrator to administer all its club membership records may electively send all the relevant club membership data to the club administrator. A club may not wish to provide unrestricted access to the whole of its club membership database, and in this case only those records of club members who demand it are conveyed to the club administrator. It is also possible for club membership to be conveyed to the club administrator by the club member, in which case the club administrator validates the subscriber's membership of the specified club with the club prior to adding it to its database. In such an embodiment, a club member who is not yet a subscriber to the club administrator can approach the club administrator directly, either by telephone or via e-mail, Internet, mail of fax and inform the club administrator that he or she is a member of one or more specified clubs. The club administrator validates this with the relevant clubs and, on finding the information to be valid, registers the member as a new subscriber to its service.

The club administrator may levy a registration fee for adding or maintaining a record in the database. Preferably, the registration fee is levied against the club on whose behalf membership of the subscriber is certified or maintained. This may be done when a new record is added and/or when an existing record is renewed. Additionally or alternatively, the registration fee may be levied against the subscriber whose membership of the club is certified or maintained. It will be appreciated that both the club and the member have a financial interest in administering the club membership data centrally via the club administrator. Thus, so far as the club is concerned, all the overhead associated with maintaining the club data is avoided. This includes correspondence with the club member, renewal reminders, accounting, updating and so on. However, clubs may nevertheless prefer to maintain their own databases and not delegate the responsibility to third parties. This is particularly likely where there is stored in the club's database data that might be confidential and which the club would therefore not wish to relay to the club administrator. In those cases where the club, for one reason or another, prefers to maintain its own database, it is sufficient to make accessible to the club administrator that part of their database relating to basic details of a club member and possibly cellular telephone number, in the case where the portable subscriber unit is a cellular telephone. So far as the club member is concerned, the major savings of administering the club membership data centrally via the club administrator translate into the convenience of not having to carry a large number of club membership cards or of remembering which ones to take on any given occasion. Moreover, any changes in personal data, such as address, telephone number, e-mail address and so on can be communicated once only to the club administrator thus ensuring that all clubs of which he or she is a member are duly notified. This not only saves time and postage for the club member, but more importantly saves the need to keep track of each club, since it is all too easy to forget to inform a club of a change of address, thus risking important information being lost in the mail. Furthermore, in the case where the subscriber unit is a cellular telephone, the cellular service provider can administer any registration and renewal fees simply by adding the relevant charges to the subscriber's monthly telephone bill.

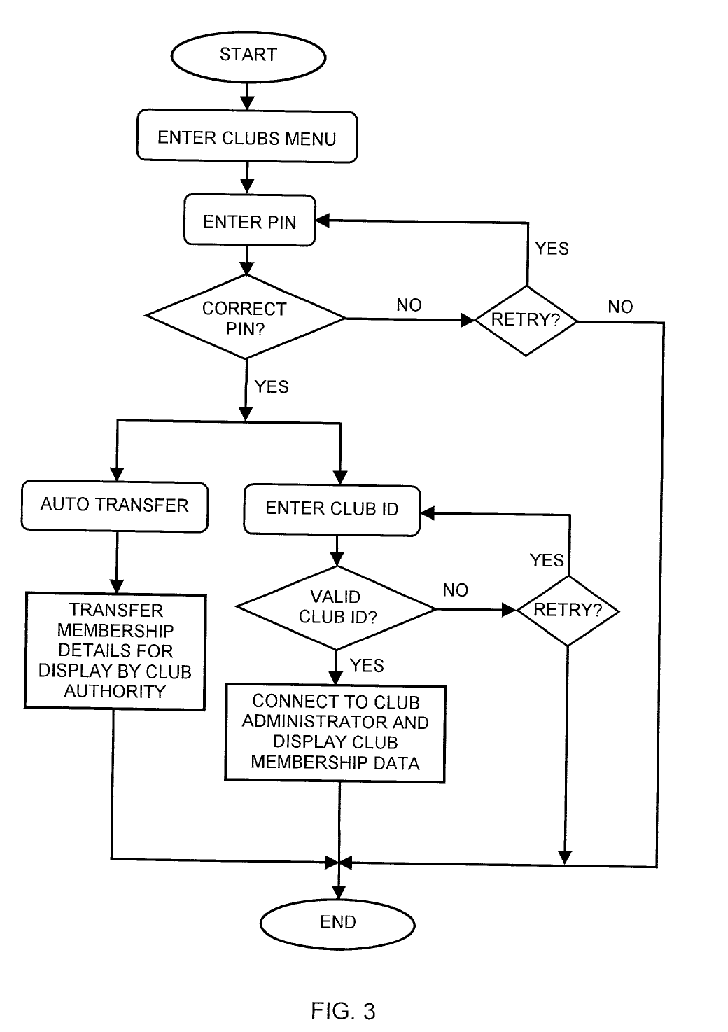

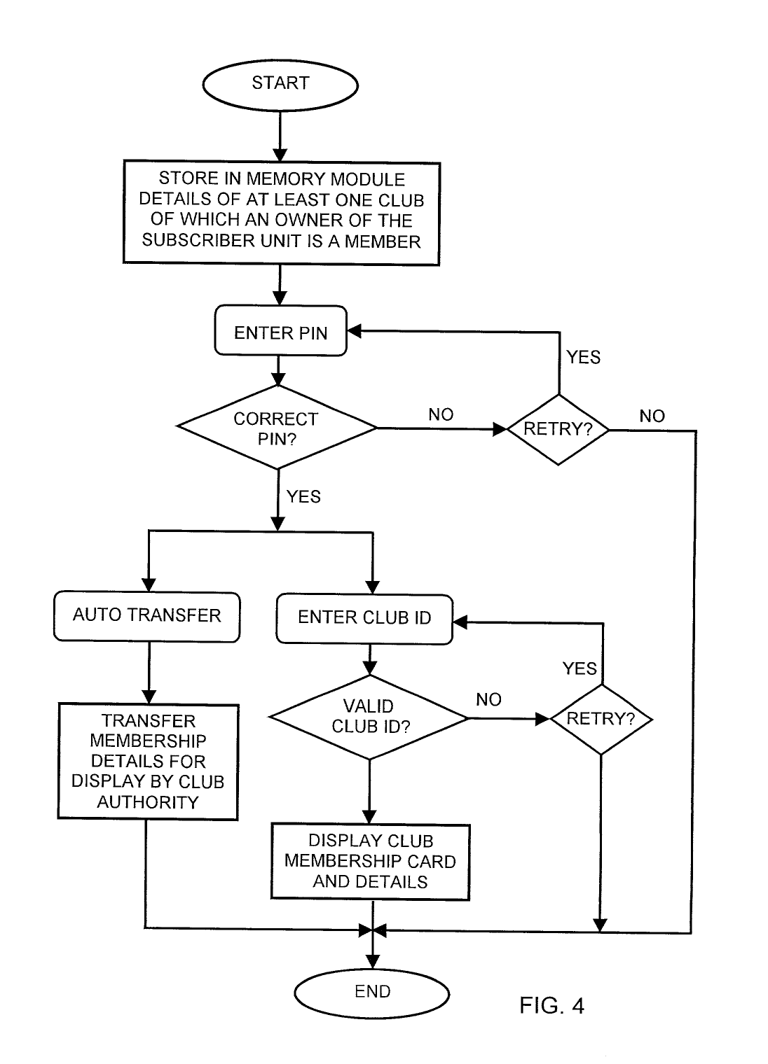

FIGS. 3 and 4 summarize the principal method steps carried out by the portable subscriber unit for administering membership of a club.. Essentially, the user enters a PIN, which may be verified locally by software in the subscriber unit. If the PIN is valid, details of at least one club of which an owner of the subscriber unit is a member are downloaded from a club administrator and displayed on a display device of the subscriber unit. Optionally, the downloaded data may be stored in a memory of the subscriber unit so as to allow local access thereto by the owner. As noted above, the data may include identity data certified by the club administrator and attesting to the validity of the identity of the consumer.

The owner may enter an instruction to disable the information stored in the subscriber unit, thereby disabling the stored subscriber unit information. In the case where the subscriber unit is a cellular telephone, the disabling may be effected by the cellular service provider (constituting a public utility). Thus, the cellular service provider may maintain a list of registered subscriber units that are authorized to use the service. Upon the subscriber informing the cellular service provider that his or her cellular telephone is lost, for example, the service provider merely updates its list so as to disable the appropriate subscriber unit. This prevents the subscriber unit from contacting the club administrator. However, it may not in itself prevent local use of the subscriber unit, since disabling the subscriber unit from effecting regular cellular communication (which is easily achieved by the cellular service provider) would still, allow access to the data in the memory module of the cellular subscriber unit. In order to prevent local access also, a flag may be stored in the memory of the subscriber unit and may be set to indicate that the subscriber unit is disabled, thus preventing access to any data stored therein and likewise preventing communication by the subscriber unit to the club administrator. The cellular service provider downloads data to the cellular subscriber unit to set or reset the disable flag, in the same way that new software may be downloaded by the cellular service provider to the cellular subscriber unit.

Another feature provided in the subscriber unit is referred to in FIGS. 3 and 4 as “Auto Transfer” and allows the subscriber unit to automatically convey data indicative of membership of a specific club to an authorized officer of the club so as to prove membership of the specific club. For example, supermarkets and other chain stores often operate their own “clubs” offering special deals to club members. When a customer pays at the checkout terminal, she presents her club membership card to the teller (constituting “an authorized officer of the club”). Typically, hitherto-proposed membership cards have a magnetic stripe and the card is swiped manually by the teller through a magnetic card reader in known manner, so as to attest to the customer's membership of the club and to record the current transaction as a “club transaction”. The “Auto Transfer” of the present invention allows the customer's personal details to be transferred automatically (e.g. by RF or IR or during the act of swiping a magnetic stripe) to the teller's cash register, thus obviating the need for entering the data manually, and saving time and also possibly wear and tear on the membership card.

When used in “on-line” mode, the subscriber unit conveys to the club administrator a personal identity code (PIN) for accessing information in the club administrator's database. The club administrator verifies that the PIN is correct and, if so, allows the subscriber unit to download data from the database. Also, in this mode, the subscriber unit can upload data to the database.

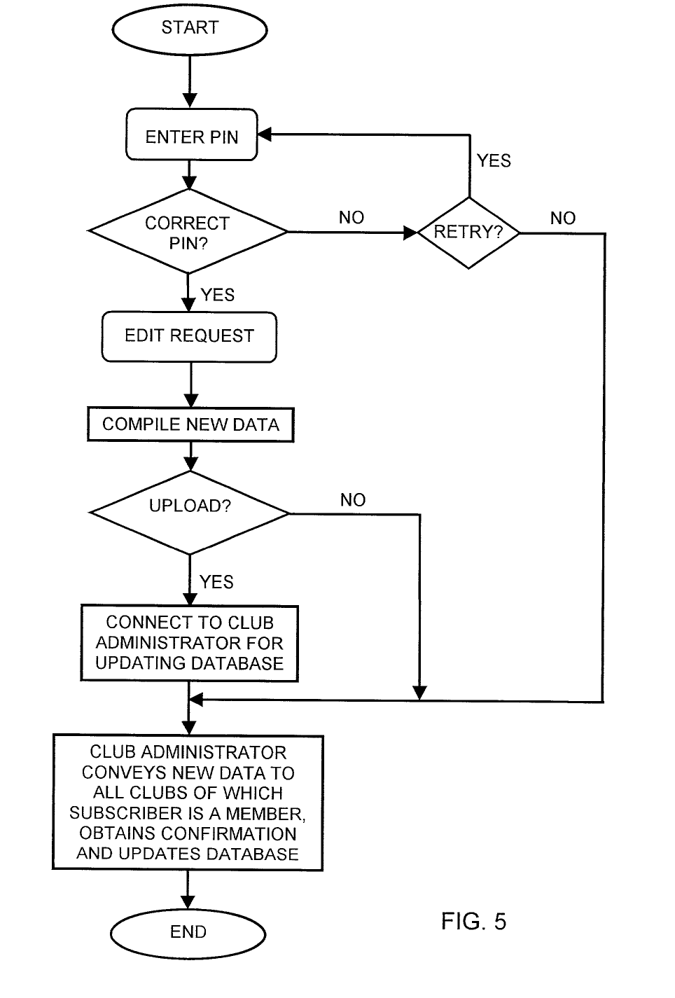

FIG. 5 summarizes the main steps associated with this mode of operation. Thus, the subscriber enters his or her PIN, which is verified locally and, if valid, allows access by the user to the memory module in the subscriber unit and to the database maintained by the club administrator. The user is thus permitted to display data stored in the memory module and to edit it for the purpose of conveying modified data to the club administrator. For example, personal details of the subscriber such as name, address and so on can be edited locally and then conveyed to the club administrator for amending the appropriate records in the database maintained by the club administrator. The amended data is conveyed by the subscriber unit to the club administrator, who conveys it to all the relevant clubs. On receiving their confirmation that the amended data in respect of the specified club member have been recorded, the club administrator effects the necessary change to the database maintained by the club administrator. This feature allows the club administrator to update all its records in respect of a subscriber while ensuring data integrity, and obviates the need for the subscriber to inform each club separately.

The subscriber may thus request that subscriber-specific fields be updated such as personal data relating to name, address, telephone number and so on. Upon receiving no objection by the clubs to the amendments or after authenticating the data in any suitable manner, the club administrator reflects the amendments in the database maintained by the club administrator. However, as shown in FIG. 2, the clubs may also request amendment to the database to reflect, for example, changes to a club member's discount, bonus points and so on. Upon receipt of such requests by the clubs, the club administrator edits the database to reflect the required changes.

It should also be noted that data stored in the memory module of the subscriber unit can be updated remotely only by the club administrator. This is of particular importance for reflecting renewed club subscriptions in the memory module of the subscriber unit since, were this not done, the subscriber unit could not be used in off-line mode in respect of subscriptions that may have lapsed—even though they were renewed by the club administrator.

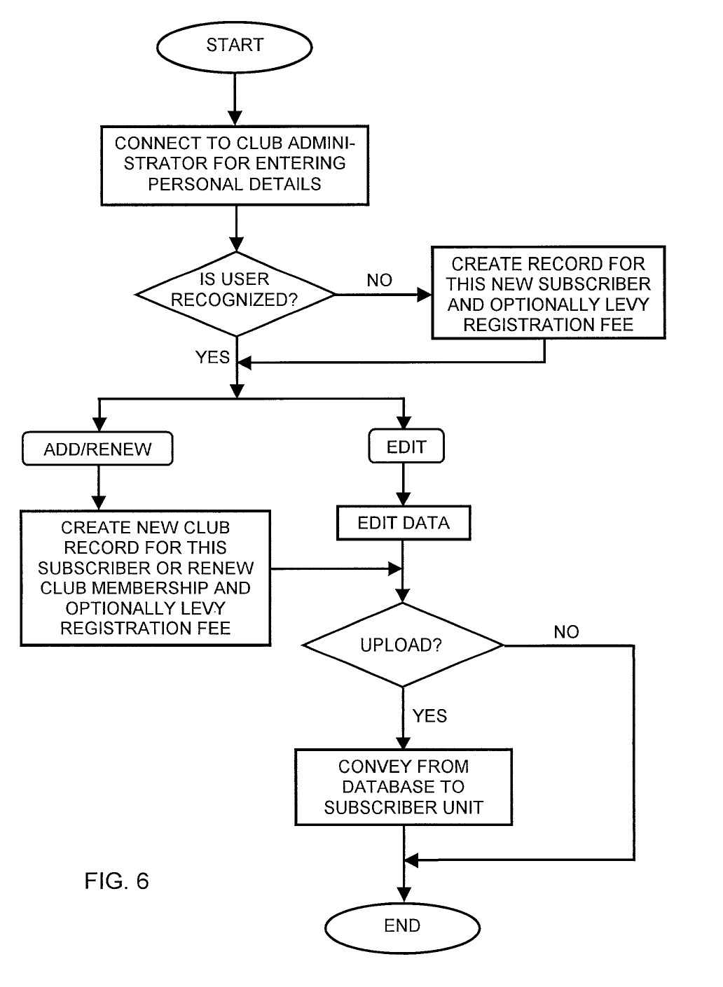

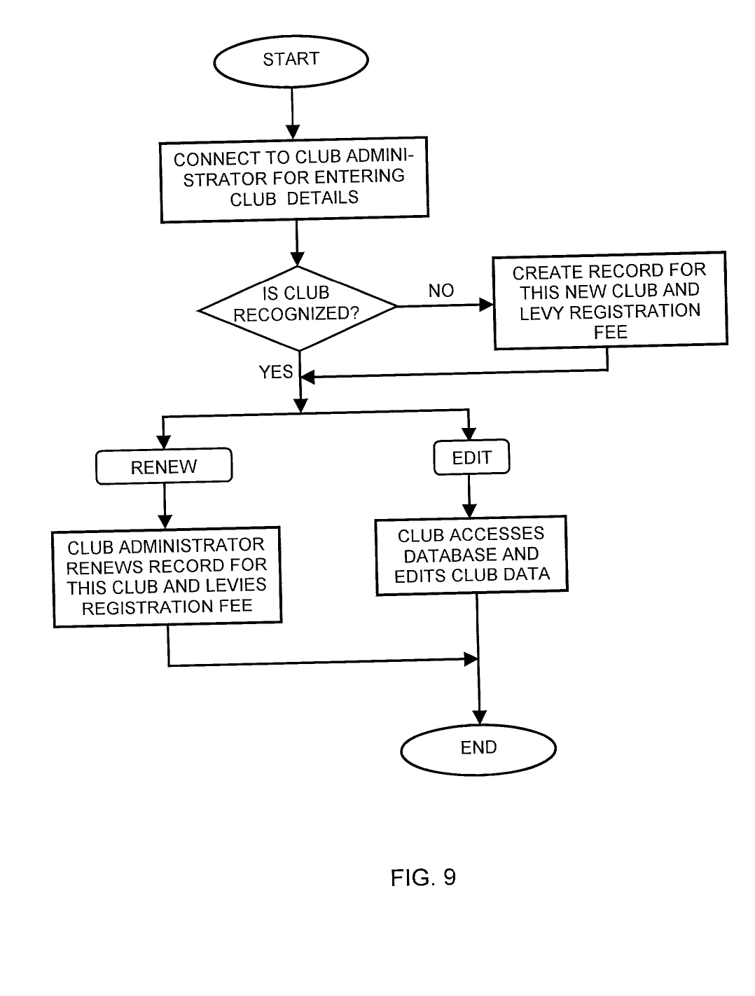

Reference has been above to registration fee that may be levied by the club administrator for adding or maintaining a record in the database. It is envisaged that typically any registration fee is levied against the club as is also done when a club registers with the club administrator or has its membership renewed as shown in FIG. 9. However, for the sake of completeness, the invention does not discount the possibility to levy a service charge against the subscriber himself as shown in FIG. 6. Thus, the subscriber may pay a registration fee to the club administrator when registering and when the club administrator modifies a record in the database and conveys to the subscriber unit for storage in the memory module thereof. In any event, any data conveyed to the club administrator by the subscriber is first confirmed with the clubs before reflecting any changes to the club administrator's database.

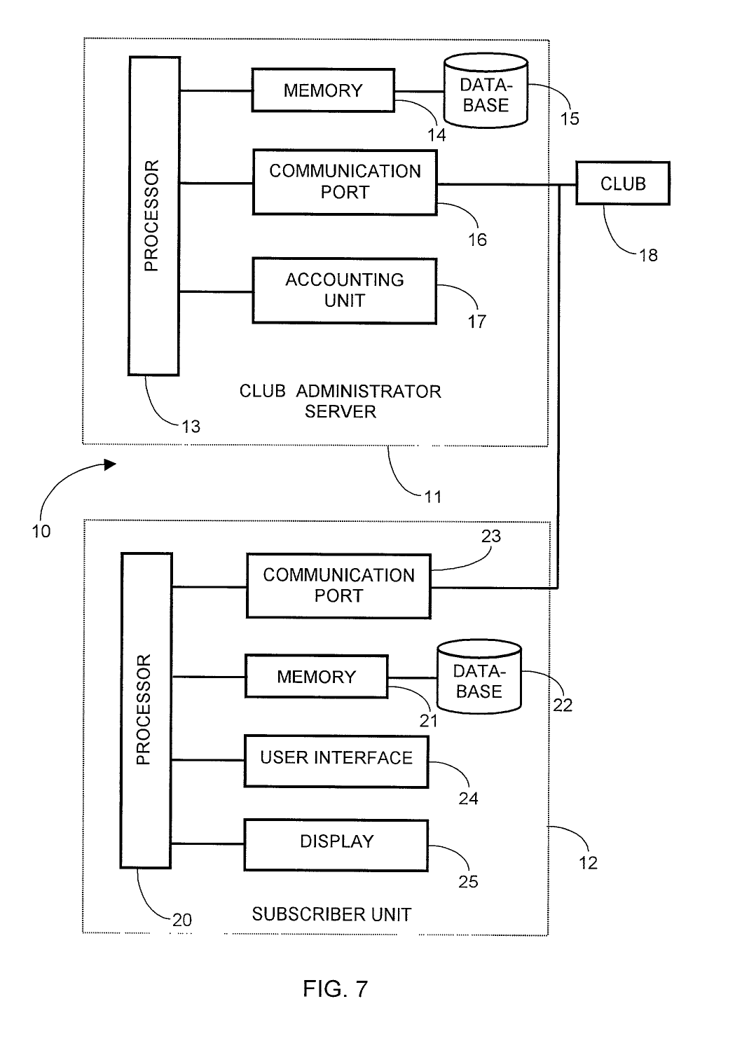

FIG. 7 shows a system depicted generally as 10 comprising a club administrator server 11 and a portable subscriber unit 12 for administering membership of a club. The club administrator server 11 comprises a processor 13 coupled to a memory 14 capable of accessing a database 15. The database 15 may be stored in the memory 14 or may be remotely accessed by the club administrator server 11. A communication port 16 coupled to the processor 13 allows communication with the subscriber unit 12, and an accounting unit 17 also coupled to the processor 13 allows the club administrator server 11 to levy a fee for use of the system against either a registered subscriber or a registered club 18.

The portable subscriber unit 12 is preferably a cellular telephone or a smart card comprising a processor 20 coupled to a memory 21 storing therein a database 22. In the case that the portable subscriber unit 12 is a cellular telephone, the memory 21 may be a customized memory module that is purchased separately from the cellular telephone and inserted therein by the cellular service provider or an agent thereof. It may also be provided by the manufacturer as an integral unit with the cellular telephone. A communication port 23 is coupled to the processor 20 for communicating with the club administrator server so as to download therefrom the details of at least one club of which an owner of the subscriber unit 12 is a member. A user interface 24 coupled to the processor 20 allows for a user to enter data and to select a club, membership of which is to be certified. This may be done, for example, by displaying a scrollable list of clubs of which the subscriber is a member, so as to allow the user to scroll to the required club for selection. The selection procedure can be enhanced using keyword and alphabetic search techniques, as are well known in the art and are used on cellular telephones to select stored telephone numbers for direct dialing. A display 25 is coupled to processor 20 for displaying membership certification and other details pertaining to the club. The display 25 constitutes a certification unit that is used to certify membership certification of at least one club, data of which is stored in the memory 21. In such case, membership certification is conveyed to the club visually. However, the display 25 could conceivably be dispensed with in cases where the membership certification is conveyed electronically to the club, via infrared, short-range RF, Bluetooth and other equivalent methods of data communication.

According to an even more advanced mode of selection, the club 18 can itself recognize that the subscriber unit 12 is a registered member of the club by remotely querying the database 22 stored in the subscriber unit 12. This obviates the need for certification to be displayed and thus obviates the need for the subscriber unit 12 to have a display device. The subscriber unit 12 could then be a smart card adapted for communication with a card reader in the club using well-known techniques.

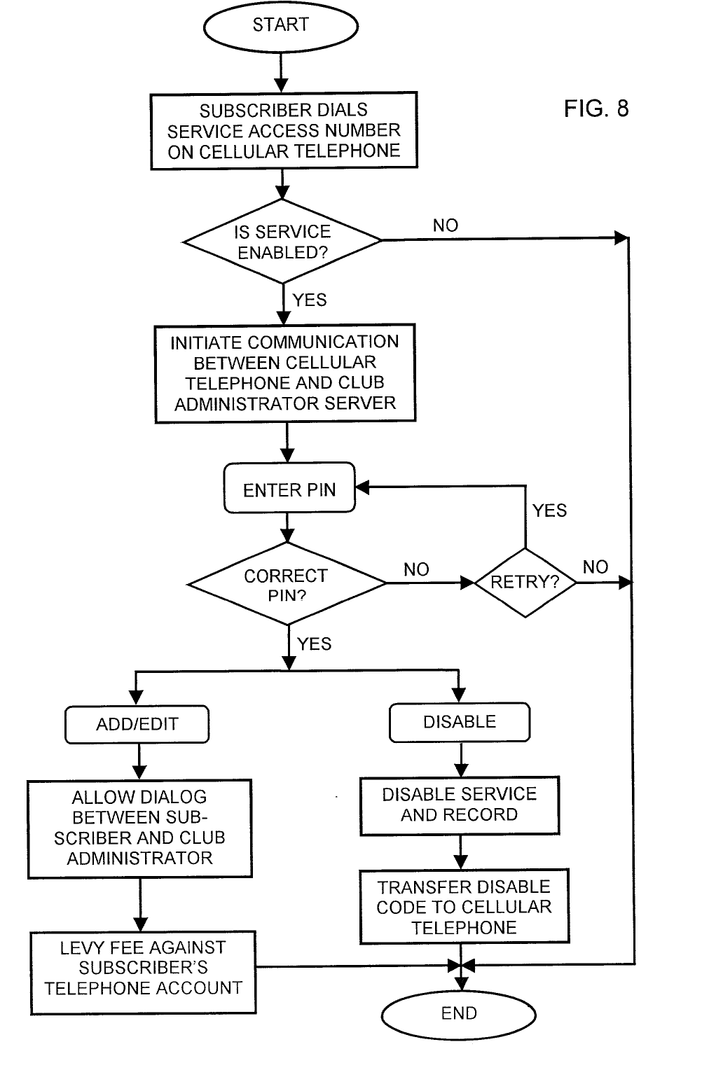

FIG. 8 shows the principal steps relating to a novel service provided by a cellular service provider (constituting a “public utility”) for administering membership of a club by a club member who is a registered subscriber of the cellular service provider. In accordance with such a service, the cellular service provider facilitates communication between the portable subscriber unit 12 used by the club member and the club administrator 11. An identity of the subscriber unit is forwarded to the club administrator so as to allow the club administrator to authenticate the subscriber, and the verified club member may then download data from the database 15 maintained by the club administrator and to upload data thereto. Preferably, such a service is accessed via a unique access code dialed by the subscriber, such as “*891” and may be charged at a special tariff as a periodic charge appearing on the subscriber's telephone bill.

Additional security may be provided by allowing the subscriber to enter a personal identity code (PIN) for accessing information in the database 15, in which case, the PIN may entered using the cellular telephone's keypad and communicated to the club administrator 11 for further authenticating the subscriber. The service can be disabled by the service provider upon receipt of a verified instruction from the subscriber. Likewise, if the cellular telephone is reported as lost or stolen, it can be disabled by the cellular service provider both locally and remotely, as explained above.

FIG. 9 shows the principal operating steps associated with a registration and renewal process carried out in association with a club that wants to register with the club administrator, so as to allow club members to enjoy the benefits of the invention. Upon connecting to the club administrator server, the club enters details permitting its identification by the club administrator. If the club is not recognized and is thus a new club, the club administrator creates a record for the new club and levies a registration fee. A recognized club may edit data in the database 22 and may renew its membership, either when prompted by the club administrator or on its own initiative. The club administrator levies a registration fee against the club on renewal of its membership.

FIG. 10 is a flow diagram showing the principal operating steps associated with a method according to the invention for allowing simplified membership to one or more consumer clubs. The club administrator maintains a network of sales outlets for allowing a consumer to register with the consumer club administrator and apply for membership of one or more consumer clubs. To this end, there may be provided a chain of retail stores that sell and promote the consumer clubs to the consumers. The outlets may be like Internet cafes, equipped with computers coupled to the club administrator over the Internet or any other data communications network. They may be provided with catering and library facilities so as to entice consumers to relax and browse promotional material provided by the club administrator on behalf of all consumer clubs registered therewith. In this context, “browsing” includes Internet browsing for those who are computer literate and conventional browsing of promotional literature that is catalogued by a librarian or hostess and provides assistance to those requiring it. For such consumers, the hostess will answer questions, help to complete a subscription application form and take a digital photograph of the subscriber. The hostess will then transmit the applications to the administrator for forwarding to the different clubs. The promotional material allows the consumer to decide which consumer club or clubs he wishes to join. Such selection is done at the consumer's convenience and not when waiting in the checkout with heavy purchases that he wishes to pay for as a consumer club member, as is currently often done. The consumer logs on to the club administrator's server and selects a consumer club for joining and an identity thereof In the case that the consumer is not yet registered with the club administrator, the club administrator's server will upload a registration form to the consumer's computer allowing the consumer to complete a one-time registration procedure. This will require the consumer to provide all the personal details required by the club administrator and by the consumer clubs themselves. There may also be provided a digital camera for allowing the consumer to be photographed and for a digital image to be recorded in the club administrator's database to serve as identity data, as explained above.

In the case that the subscriber unit is a cellular telephone, the subscriber must inform the club administrator of its access number during the registration process. Optionally, he or she may also enter a secret access code serving as a PIN code. In the case that a smart card is to be used as the subscriber unit, this can be provided by the club administrator at the sales outlet and customized for the new consumer.

The consumer's application including the consumer's personal details, is forwarded to each consumer club that the consumer wishes to join, and the club administrator awaits approval from each consumer club thus confirming that the consumer's application is acceptable. Upon receiving approval from the consumer clubs, the club administrator's database is updated accordingly. The club administrator may then levy a registration fee against the consumer club in respect of each new member. In order to encourage consumers to join consumer clubs under its aegis, the club administrator may send promotional material to the consumer's subscriber unit in the form of text messages that are displayed on a display device thereof.

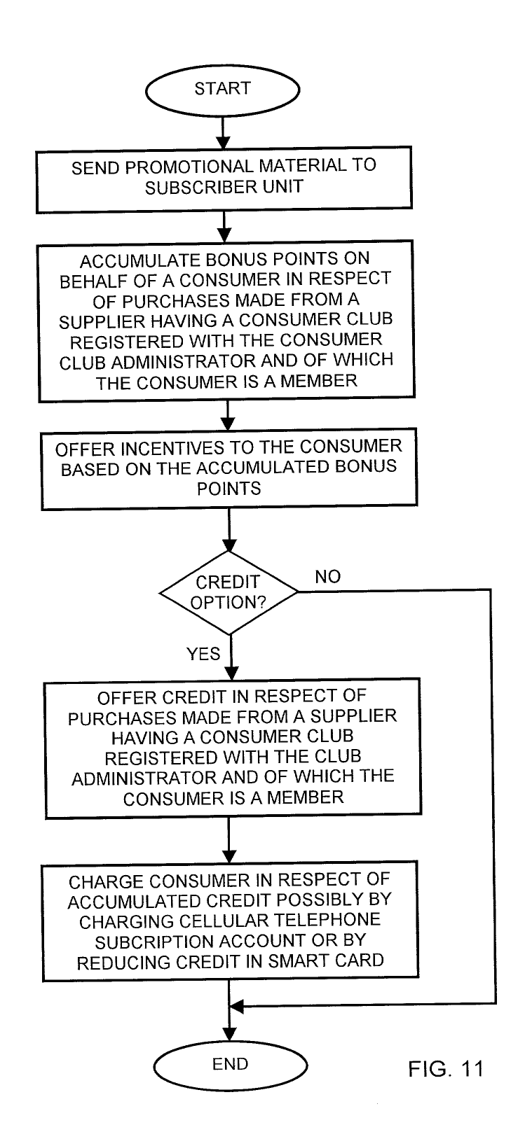

FIG. 11 is a flow diagram showing the principal operating steps associated with a method according to the invention for promoting consumer clubs and financing transactions made by consumers when purchasing from stores operating consumer clubs of which the consumer is a member. Thus, the club administrator or the consumer club or an affiliate thereof can send promotional messages to the consumer's subscriber unit. These can be in the form of text messages appearing on a display device of the subscriber unit. Such messages can be sent by the club administrator to all members of a specified consumer club in order to encourage a consumer to purchase goods or services from a supplier on whose behalf the consumer club is operated. They can also be sent during a shopping expedition, while the consumer is actually on the supplier's premises. In the case that such messages are sent on behalf of the consumer club by the club administrator, the club administrator may levy a promotion fee against the consumer club.

The club administrator may also maintain incentives on behalf of the consumer clubs registered with the consumer club administrator. For example, bonus points (such as flying miles) may be issued to favored consumers in return for frequent patronage and accumulated on behalf of the consumer. Incentives may be offered to the consumer based on the accumulated bonus points. The organization of all the clubs under one roof will allow the customer to add his purchases to the pool of accumulated “points” of several clubs. This will give the customer a better and more realistic opportunity to receive awards (gifts and perks) which will be financed by all the clubs together. For example, instead of having points spread out in different clubs and never accumulating enough points to receive an acceptable gift, customers of the combined club run by the club administrator will have all their points in one pool and will be able to accumulate points and redeem them for attractive gifts.

Most stores today accept credit cards, partly because it provides a mechanism for guaranteed payment and partly to remain competitive. However, receiving payment by credit card requires the store to pay a percentage of the transaction account to the credit card company. Some large stores operate their own credit cards precisely to avoid having to siphon off part of their profits to the credit card company. In accordance with the invention, the club administrator may also operate a credit scheme whereby it supplies credit to the consumer in respect of purchases made from a supplier having a consumer club registered with the consumer club administrator and of which the consumer is a member. This has many advantages to the suppliers operating the consumer clubs. Principally, it means that they do not have to pay the transaction percentage to the credit card company. It also means that the supplier himself or his consumer club are no longer responsible for chasing payment from the consumer and it obviates the need for suppliers to operate their own credit schemes and allows all participating consumer clubs to enjoy the joint economies of scale.

The club administrator periodically charges the consumer in respect of credit accumulated against the consumer. In the case that the subscriber unit is a cellular telephone, for example, or is operated in conjunction with a service utility, the accumulated credit may be charged directly against a subscription account of the subscriber unit. In the case that the subscriber unit is a smart card operating as a debit card, the accumulated credit may be debited from an accumulated credit associated with the smart card.

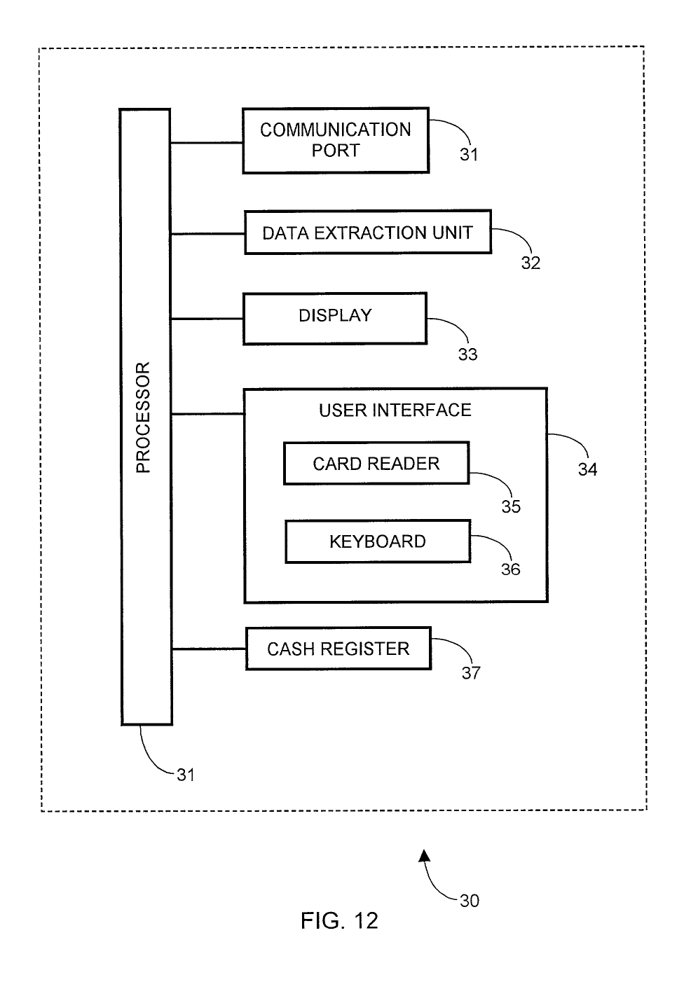

FIG. 12 is a block diagram showing functionally a consumer module 30 used by an authorized officer of the club for interrogating a consumer's subscriber unit. The club module 30 comprises a processor 31 coupled to a communication port 31 allowing connection to a database containing details of consumers who are members of the consumer club. The database may be stored locally in a memory either within the club module 30 or in a computer server connected thereto. It may also be stored remotely and accessed by the club module 30 via a communications network such as the Internet. A data extraction unit 32 is coupled to the processor 31 for querying the database in order to determine whether a target consumer is a member of the consumer club and a display 33 coupled to the processor 30 allows data relating to the consumer to be displayed. In order that the appropriate record form the database can be read, the identity of the target consumer must be determined. To this end there is provided an identity unit for receiving an identity of the target consumer. In the case that the portable subscription unit used by the consumer is a cellular telephone or other radio-frequency (RF) device, the identity unity may be an RF reader data within the extraction unit 32 for reading the portable subscription unit automatically. For other types of portable subscription unit, the identity unit may be constituted by a user interface 34 comprising a card reader 35 and a keyboard 36 allowing a portable subscription unit in the form of a smart card or a magnetic card to be read; or allowing a serial number thereof to be entered manually via the authorized officer of the club. The club module 30 may also include an integral cash register 37 coupled to the processor 31 and useful for store checkouts and the like.

The club administrator may optionally be accessed via the Internet or via an intranet and it will be appreciated that the system according to the invention as well as its various sub-components may be realized by suitably programmed computers. In the case that data is accessed online by the subscriber unit, there is no need to dial a special service offered by the cellular service provider or to maintain a memory module in the subscriber unit. Instead, the subscriber unit may include a communication port for connecting to the club administrator over the Internet. The subscriber unit may be a smart card or magnetic card that is swiped through a card reader connected to the club administrator site over the Internet for allowing the subscriber's ID automatically to be read from the card and conveyed to the club administrator site; and to allow authorization to be received from the club administrator site.

In those cases where the subscriber unit includes a memory module, there may further be included an infrared transmitter or Bluetooth communication or any other suitable short-range RF communication for allowing the subscriber unit to convey the data to the club. This is useful when the club is a store at which the subscriber has an account, since the subscriber unit can communicate directly with the cash register or with a similar device for proving that the subscriber is a member of the store's consumer club. This avoids the need to swipe the card through the cash register or associated device.

Likewise, the invention contemplates a computer program being readable by a computer for executing the various methods of the invention. The invention further contemplates a machine-readable memory tangibly embodying a program of instructions executable by the machine for executing the various methods of the invention.

In the method claims that follow, alphabetic characters used to designate claim steps are provided for convenience only and do not imply any particular order of performing the steps.

1. A method for administering membership of a consumer club, comprising the following steps all carried out by a club administrator:
(a) maintaining a database of subscribers and details of each consumer club of which each subscriber is a member, and
(b) conveying to a portable subscriber unit details of at least one club for certifying membership of the at least one club.

2. The method according to claim 1, wherein step (b) includes:
i) storing said details in a memory module for embedding in the portable subscriber unit.

3. The method according to claim 1, further including the step of:
(c) conveying to the subscriber unit information in the database relating to a registered owner of the subscriber unit for storage therein so as to allow local access thereto by said owner.

4. The method according to claim 3, further including:
(d) disabling the subscriber unit from accessing information stored in the subscriber unit in response to a request by the owner thereof.

5. The method according to claim 1, wherein the subscriber unit is a cellular subscriber unit.

6. The method according to claim 1, wherein the subscriber unit is a smart card.

7. The method according to claim 1, wherein step (b) further includes:
i) receiving a personal identity code (PIN) for accessing information in said database,
ii) verifying the PIN, and
iii) conveying said details only if the PIN is valid.

8. The method according to claim 3, wherein step (c) further includes:
i) receiving a personal identity code (PIN) for accessing information in said database,
ii) verifying the PIN, and
iii) conveying said details only if the PIN is valid.

9. The method according to claim 4, wherein step (d) further includes:
i) receiving a personal identity code (PIN) for accessing information in said database,
ii) verifying the PIN, and
iii) conveying said details only if the PIN is valid.

10. The method according to claim 3, further including the step of:
(a) updating information stored in the subscriber unit.

11. The method according to claim 10, wherein the subscriber unit is a cellular subscriber unit.

12. The method according to claim 1, further including the step of:
(c) storing information that is contained in the database relating to a registered owner of the subscriber unit in a memory module for embedding in said subscriber unit.

13. The method according to claim 12, further including:
(d) conveying to the subscriber unit for storage in the memory module thereof identity data for display on a display device of the subscriber unit.

14. The method according to claim 13, wherein the identity data includes data representative of an image of the owner.

15. The method according to claim 1, further including:
(d) maintaining a network of outlets for allowing a consumer to register with the consumer club administrator and apply for membership of one or more consumer clubs.

16. The method according to claim 15, further including:
(d) providing marketing information relating to consumer clubs registered with the club administrator for allowing the consumer to decide which consumer club or clubs he wishes to join.

17. The method according to claim 15, further including:
(d) forwarding an application to each consumer club that the consumer wishes to join, said application including personal details of the consumer,
(e) receiving from the consumer clubs acceptance of the consumer's application, and
(f) updating the database to reflect the consumer's membership of each consumer club which confirms the consumer's application.

18. The method according to claim 17, further including:
(d) receiving said personal details of the consumer during a one-time only registration process.

19. The method according to claim 18, wherein the registration process further includes obtaining identity data of the consumer for uploading to the consumer's portable subscriber unit.

20. The method according to claim 19, wherein the identity data includes data representative of an image of the owner.

21. The method according to claim 15, further including:
(e) levying a promotion fee against each of the consumer clubs for promoting the consumer clubs.

22. The method according to claim 15, further including:
(f) levying a subscription fee against each of the consumer clubs to which a consumer applies for membership.

23. The method according to claim 1, further including:
(d) maintaining incentives on behalf of the consumer clubs registered with the consumer club administrator.

24. The method according to claim 23, including:
(g) accumulating bonus points on behalf of the consumer in respect of purchases made from a supplier having a consumer club registered with the consumer club administrator and of which the consumer is a member, and
(h) offering incentives to the consumer based on the accumulated bonus points.

25. The method according to claim 1, further including:
(d) supplying credit to the consumer in respect of purchases made from a supplier having a consumer club registered with the consumer club administrator and of which the consumer is a member, and
(e) periodically charging the consumer in respect of credit accumulated against said consumer.

26. The method according to claim 25, wherein the accumulated credit is charged directly against a subscription account of the subscriber unit.

27. The method according to claim 25, wherein the accumulated credit is debited from an accumulated credit associated with the subscriber unit.

28. The method according to claim 1, further including:
(d) transmitting a message to the subscriber unit for display on a display device thereof.

29. The method according to claim 28, wherein the message relates to a promotion currently being offered by a supplier having a consumer club registered with the consumer club administrator and of which the consumer is a member.

30. The method according to claim 1, further including the step of:
(e) levying a registration fee against the consumer club for adding or maintaining a record in the database.

31. The method according to claim 15, wherein step (e) includes:
i) levying the registration fee against the consumer club on whose behalf membership of the subscriber is certified.

32. The method according to claim 30, wherein step (e) includes:
ii) levying the registration fee against the subscriber whose membership of the club is certified.

33. The method according to claim 1, further including:
(h) receiving details of members of a consumer club that is registered with the club administrator, and
(i) adding said details to the database.

34. The method according to claim 1, further including:
(j) registering a consumer club with the club administrator,
(k) receiving details of the consumer club including details of members thereof, and
(l) adding said details to the database.

35. The method according to claim 34 further including:
(m) levying a registration fee against the consumer club in respect of details added to the database.

36. A method for administering membership of a consumer club, comprising the following steps all carried out by a portable subscriber unit or by an owner thereof:
(a) downloading from a club administrator details of at least one consumer club of which an owner of the subscriber unit is a member, and
(b) using the subscriber unit to certify membership of said at least one consumer club.

37. The method according to claim 36, wherein step (b) includes displaying membership certification of the at least one consumer club on a display device of the subscriber unit.

38. The method according to claim 36, further including the step of:
(c) storing said details in a memory of the subscriber unit so as to allow local access thereto by the owner.

39. The method according to claim 38, further including:
(d) displaying identity data of the registered member of at the least one consumer club identity data on a display device of the subscriber unit.

40. The method according to claim 39, wherein the identity data includes data representative of an image of the registered member.

41. The method according to claim 38, further including:
(d) receiving an instruction to disable the subscriber unit information stored in the subscriber unit, and
(e) disabling the stored subscriber unit information.

42. The method according to claim 35, wherein the subscriber unit is a cellular subscriber unit.

43. The method according to claim 35, wherein the subscriber unit is a smart card.

44. The method according to claim 35, wherein step (b) includes automatically conveying data indicative of membership of a specific club to an authorized officer of said club so as to prove membership of the specific club.

45. The method according to claim 35, wherein step (a) further includes:
i) conveying to the club administrator a personal identity code (PIN) for accessing information in said database, and
ii) downloading data only if the PIN is verified as valid by the club administrator.

46. A method for administering membership of a club, comprising the following steps all carried out by a portable subscriber unit:
(a) storing in a memory of the subscriber unit details of at least one consumer club of which an owner of the subscriber unit is a member, and
(b) conveying membership certification of said at least one consumer club to said at least one club.

47. The method according to claim 46, further including:
(c) receiving an instruction to disable the subscriber unit information stored in the subscriber unit, and
(d) disabling the stored subscriber unit information.

48. The method according to claim 46, wherein step (b) includes displaying membership certification of the at least one consumer club on a display device of the subscriber unit for conveying visually to the at least one consumer club or an affiliate thereof.

49. The method according to claim 46, further including automatically conveying data indicative of membership of a specific consumer club to an authorized officer of said consumer club or of an affiliate thereof so as to prove membership of the specific consumer club.

50. The method according to claim 46, further including the steps of:
(e) receiving update information from the club administrator server, and
(f) updating the information in the memory of the subscriber unit.

51. The method according to claim 46, further including the steps of:
(e) downloading identity data for display on a display device of the subscriber unit.

52. The method according to claim 51, wherein the identity data includes data representative of an image of the owner.

53. A portable subscriber unit for administering membership of a consumer club, comprising:
a communications port for downloading from a club administrator details of at least one consumer club of which an owner of the subscriber unit is a member, and
a certification unit coupled to the communications port for certifying membership certification of said at least one consumer club.

54. The portable subscriber unit according to claim 53, further including:
a memory coupled to the communications port for storing said details so as to allow local access thereto by the owner.

55. The portable subscriber unit according to claim 53, further including:
a user interface for entering data and selecting a consumer club, membership of which is to be certified.

56. The portable subscriber unit according to claim 53, being a cellular telephone.

57. The portable subscriber unit according to claim 53, being a smart card.

58. A club administrator server for administering membership of a consumer club, comprising:
a processor capable of accessing a database,
a communication port coupled to the processor for communicating with a subscriber unit belonging to a member of a consumer club administered by the club administrator server.

59. The club administrator server according to claim 58, including a memory coupled to the processor for storing the database therein.

60. The club administrator server according to claim 58, wherein the communication port is adapted to be coupled under control of the processor to a consumer club for registering the consumer club in the database.

61. The club administrator server according to claim 58, further including an accounting unit coupled to the processor for levying a fee for use of the club administrator server.

62. The club administrator server according to claim 61, wherein the accounting unit is adapted to levy a fee against the consumer club.

63. The club administrator server according to claim 61, wherein the accounting unit is adapted to levy a fee against the club member.

64. A program storage device readable by machine, tangibly embodying a program of instructions executable by the machine to perform method steps for administering membership of a consumer club, comprising the following steps:
(a) maintaining a database of subscribers and details of each consumer club of which each subscriber is a member, and
(b) conveying to a portable subscriber unit details of at least one consumer club for certifying membership of the at least one consumer club.

65. A computer program product comprising a computer useable medium having computer readable program code embodied therein for administering membership of a consumer club, the computer program product comprising:
computer readable program code for causing the computer to maintain a database of subscribers and details of each consumer club of which each subscriber is a member, and
computer readable program code for causing the computer to convey to a portable subscriber unit details of at least one consumer club for certifying membership certification thereof.

66. A program storage device readable by machine, tangibly embodying a program of instructions executable by the machine to perform method steps for administering membership of a club, comprising the following steps:
(a) downloading from a club administrator details of at least one consumer club of which an owner of the subscriber unit is a member, and
(b) certifying membership certification of said at least one consumer club.

67. A computer program product comprising a computer useable medium having computer readable program code embodied therein for administering membership of a club, the computer program product comprising:
computer readable program code for causing the computer to download from a club administrator details of at least one consumer club of which an owner of the computer is a member, and
computer readable program code for causing the computer to certify membership of said at least one consumer club.

68. A program storage device readable by machine, tangibly embodying a program of instructions executable by the machine to perform method steps for administering membership of a club, comprising the following:
(a) storing in a memory of the subscriber unit details of at least one consumer club of which an owner of the subscriber unit is a member, and
(b) certifying membership certification of said at least one consumer club.

69. A computer program product comprising a computer useable medium having computer readable program code embodied therein for administering membership of a consumer club, the computer program product comprising:
computer readable program code for causing the computer to store in a memory of the computer details of at least one consumer club of which an owner of the computer is a member, and
computer readable program code for causing the computer to certify membership certification of said at least one consumer club.

70. A service provided by a public utility for administering membership of a consumer club by a club member, said service comprising:
(a) facilitating communication between a portable subscriber unit used by the club member and a club administrator that administers membership of the consumer club on behalf of the club member,
(b) forwarding an identity of the subscriber unit to the club administrator, and
(c) allowing the club member to download data from a database maintained by the club administrator and to upload data thereto.

71. The service according to claim 70, wherein the public utility is a cellular service provider and the subscriber unit is a cellular telephone.

72. The service according to claim 71, further including:
(e) providing a unique service access code for dialing said service.

73. The service according to any one of claims 70, further including:
(e) allowing the subscriber to enter a personal identity code (PIN) for accessing information in said database, and
(f) communicating the PIN to the club administrator for further authenticating the subscriber.

74. The service according to claim 70, further including:
(g) levying a service fee against the subscriber by periodically charging an account held by the subscriber with the public utility.

75. The service according to claim 70, further including:
(h) receiving a verified instruction from the subscriber to disable said service, and
(i) disabling the service.

76. A program storage device readable by machine, tangibly embodying a program of instructions executable by the machine to perform method steps for allowing a subscriber unit to utilize a service provided by a public utility for administering membership of a consumer club by a club member using the subscriber unit, said method comprising:
(a) facilitating communication between the portable subscriber unit used by the club member and a club administrator that administers membership of the consumer club on behalf of the club member,
(b) forwarding an identity of the subscriber unit to the club administrator, and
(c) allowing the club member to download data from a database maintained by the club administrator and to upload data thereto.

77. A computer program product computer program product comprising a computer useable medium having computer readable program code embodied therein for allowing a subscriber unit to utilize a service provided by a public utility for administering membership of a consumer club by a club member using the subscriber unit, said computer program product comprising:
computer readable program code for causing the subscriber unit to effect communication via the public utility with a club administrator that administers membership of the club on behalf of the club member,
computer readable program code for causing the public utility to forward an identity of the subscriber unit to the club administrator, and
computer readable program code for causing the subscriber unit to download data from a database maintained by the club administrator and to upload data thereto.

78. A memory module containing a database of club membership data pertaining to a registered owner of the memory module.

79. The memory module according to claim 78, being adapted for embedding in a portable subscriber unit having a user interface for accessing the data stored in the memory module.

80. The memory module according to claim 78, containing therein data to which the portable subscriber unit is responsive for enabling or disabling access to the club membership data stored in the memory module.

81. A method for administering membership of a consumer club, comprising the following steps all carried out by a club module located in a consumer club or an affiliate thereof:
(a) connecting to a database containing details of each consumer club of which at least one subscriber is a member, and
(b) querying the database in order to determine whether a target consumer is a member of a consumer club with which the club module is associated.

82. The method according to claim 81, wherein the database is maintained by a club administrator and there are further included the steps of:
(c) receiving an identity of the target consumer, and
(d) using the identity of target consumer to query the database.

83. The method according to claim 82, wherein the identity of the target consumer is received automatically from a subscriber unit of the consumer.

84. The method according to claim 83, further including:
(e) transmitting to the subscriber unit a signal for querying the identity of the target consumer.

85. The method according to claim 81, wherein the database is stored within a subscriber unit of the target consumer and there is further included the step of:
(f) transmitting to the subscriber unit a signal for accessing and querying the database.

86. A program storage device readable by machine, tangibly embodying a program of instructions executable by the machine to perform method steps for administering membership of a consumer club, comprising the following steps all carried out by a club module located in a consumer club or an affiliate thereof:
(a) connecting to a database containing details of each consumer club of which at least one subscriber is a member, and
(b) querying the database in order to determine whether a target consumer is a member of a consumer club with which the club module is associated.

87. A computer program product comprising a computer useable medium having computer readable program code embodied therein for administering membership of a consumer club, the computer program product comprising:
computer readable program code for causing the computer to connect to a database containing details of each consumer club of which at least one subscriber is a member, and
computer readable program code for causing the computer to query the database in order to determine whether a target consumer is a member of a consumer club with which the club module is associated.

88. A club module for locating in association with a consumer club or an affiliate thereof for administering membership of a consumer club, the club module comprising:
a communication unit for connecting to a database containing details of each consumer club of which at least one subscriber is a member, and
a data extraction unit coupled to the communication unit for querying the database in order to determine whether a target consumer is a member of a consumer club with which the club module is associated.

89. The club module according to claim 88, further comprising an identity unit for receiving an identity of the target consumer.

90. The club module according to claim 89, wherein the identity unit includes a transmitter for transmitting an interrogation signal to a subscriber unit of the target consumer.

91. The club module according to claim 89, wherein the identity unit includes a reading unit for reading data stored in a subscriber unit of the target consumer.
